(19) United States
(12) Patent Application Publication
(10) Pub. No.: US 2026/0081184 A1
(43) Pub. Date: Mar. 19, 2026

(54) ELECTRODE

(71) Applicants: TOYOTA JIDOSHA KABUSHIKI KAISHA, Toyota-shi (JP); KYUSHU UNIVERSITY, NATIONAL UNIVERSITY CORPORATION, Fukuoka-shi (JP)

(72) Inventors: Yuhki YUI, Yokohama-shi (JP); Tatsumi ISHIHARA, Fukuoka-shi (JP)

(73) Assignees: TOYOTA JIDOSHA KABUSHIKI KAISHA, Toyota-shi (JP); KYUSHU UNIVERSITY, NATIONAL UNIVERSITY CORPORATION, Fukuoka-shi (JP)

(21) Appl. No.: 19/324,338

(22) Filed: Sep. 10, 2025

(30) Foreign Application Priority Data
Sep. 13, 2024 (JP) 2024-159291

(51) Int. Cl. H01M 4/90; C25B 1/04; C25B 11/071; C25B 13/07; H01M 8/12

(52) U.S. Cl. CPC H01M 4/9066; C25B 1/04; C25B 11/071; C25B 13/07; H01M 8/12; H01M 2008/1293

(57) ABSTRACT

An electrode capable of preventing Ni from being re-oxidized and reduced and thereby having improved initial characteristics and durability is provided. The electrode includes a cermet layer containing Ni-containing particles and an Nb compound. The Nb compound may cover at least parts of surfaces of the Ni-containing particles. The ratio of the mass of Nb contained in the Nb compound to the mass of Ni contained in Ni-containing particles may be 0.2 to 3.0 mass %. La may be contained in the Nb compound. The cermet layer may contain electrolyte particles having oxide ion conductivity or both oxide ion and electron conductivities.

### CROSS REFERENCE TO RELATED APPLICATIONS

This application is based upon and claims the benefit of priority from Japanese patent application No. 2024-159291, filed on Sep. 13, 2024, the disclosure of which is incorporated herein in its entirety by reference.

### BACKGROUND

The present disclosure relates to an electrode, in particular, an electrode that can be used as a hydrogen electrode of a solid oxide electrolysis cell (SOEC) or a fuel electrode of a solid oxide fuel cell (SOFC).

Electrochemical cells such as solid oxide fuel cells (SOFC) and solid oxide electrolysis cells (SOEC) both of which include a solid electrolyte layer having oxide ion conductivity have been known.

SOFCs are fuel cells using oxide ion conductors as electrolytes. When a fuel gas such as H₂, CO, and CH₄ is supplied to the anode (fuel electrode) of such an SOFC, and O₂ is supplied to the cathode (oxygen electrode) thereof, an electrode reaction proceeds, so that electric power can be obtained from the SOFC. CO₂ and H₂O generated by the electrode reaction are discharged to the outside of the SOFC.

In contrast, although an SOEC has the same structure as that of the SOFC, a reaction that is reverse of the reaction in the SOFC occurs in the SOEC. That is, CO and H₂ can be generated by supplying CO₂ and H₂O to the cathode (hydrogen electrode) of the SOEC and making a current flow between the electrodes.

A cermet made of a certain material such as Ni/YSZ, Ni/SDC, or Ni—Fe/SDC is used for the hydrogen electrode of such an SOEC in some cases. However, a water vapor, which is the raw material for producing hydrogen, is supplied to the hydrogen electrode at a high temperature (700° C. or higher). Therefore, Ni contained in the hydrogen electrode is easily oxidized, and NiO is thereby formed. Since NiO is an insulator, when NiO is formed in the electrode, the electron path is cut off and the electrolytic reaction ceases to proceed in that part. As a result, the electrolytic characteristic deteriorates.

This point is also true for SOFCs. That is, water is generated in the fuel electrode of the SOFC by the electrode reaction. Therefore, in some cases, especially under high-load operation conditions, Ni in the fuel electrode is oxidized by the generated water vapor, and the power generation characteristic deteriorates.

Therefore, there is a demand for a technology for preventing Ni from being oxidized in an electrode for an SOFC or an SOEC. As an example of such technology, Patent Literature 1 discloses an electrode including a diffusion layer and an active layer formed on a surface of the diffusion layer on the side thereof on which the electrolyte layer is disposed. The active layer of this electrode consists of a cermet (B) containing Ni-containing particles (B) and YScCZ particles consisting of ZrO₂ doped with Y, Sc, and Ce.
Patent Literature 1: Japanese Unexamined Patent Application Publication No. 2022-74189

### SUMMARY

However, for example, an SOEC operates at a high temperature of about 800° C. Therefore the technology disclosed in Patent Literature 1 has a problem that since Ni is repeatedly re-oxidized and reduced, neither sufficient initial characteristics nor sufficient durability can be obtained.

The present disclosure has been made in order to solve such problems, and an object thereof is to provide an electrode capable of preventing Ni from being re-oxidized and reduced and thereby having improved initial characteristics and durability.

An electrode according to the present disclosure includes a cermet layer containing Ni-containing particles and an Nb compound.

According to the present disclosure, it is possible to provide an electrode capable of preventing Ni from being re-oxidized and reduced and thereby having improved initial characteristics and durability.

The above and other objects, features and advantages of the present disclosure will become more fully understood from the detailed description given hereinbelow and the accompanying drawings.

### BRIEF DESCRIPTION OF DRAWINGS

FIG. 1 shows graphs showing IV characteristics of SOECs obtained in Examples 1 and 2 and Comparative Examples 1 and 2, respectively, during co-electrolysis;

FIG. 2 shows Cole-Cole plots of SOECs obtained in Example 1 and Comparative Example 1, respectively;

FIG. 3 shows graphs showing results of endurance tests of SOECs obtained in Example 1 and Comparative Example 1, respectively;

FIG. 4 shows SEM images of hydrogen electrodes after endurance tests are carried out;

FIG. 5 shows a graph of K-edge XANES spectra and a graph of K-edge radial distribution functions showing results of XANES measurements of SOECs obtained in Example 1 and Comparative Example 1, respectively;

FIG. 6 shows a graph showing K-edge XANES spectra showing results of XANES measurements for Nb oxide-coated NiO particles before and after reduction processes; and

FIG. 7 shows a graph showing a result of an analysis of a gas generated in an SOEC obtained in Example 2.

### DESCRIPTION OF EMBODIMENTS

### First Embodiment

Specific embodiments to which the present disclosure is applied will be described hereinafter in detail with reference to the drawings. However, the present disclosure is not limited to the embodiments described below. Further, the following descriptions and drawings are simplified as appropriate to clarify the explanation.

An electrode according to the present disclosure is used as a hydrogen electrode of a solid oxide electrolysis cell (SOEC) or a fuel electrode of a solid oxide fuel cell (SOFC). An electrode according to the present disclosure may instead be used as a hydrogen electrode of an SOEC or a fuel electrode of an SOFC in a solid oxide fuel cell/electrolytic cell in which the electrode is used in a reversed manner. In this embodiment, an electrode used for a hydrogen electrode of an SOEC will be described as a specific example of such electrodes.

### [Electrode]

An electrode according to the present disclosure includes a cermet layer containing Ni-containing particles and an Nb compound.

### [Ni-Containing Particle]

The Ni-containing particles are metal particles in which the mass ratio of Ni to the total mass of the metal elements contained in the particles is 90 mass % or higher. The mass ratio of Ni contained in the Ni-containing particles is preferably 95 mass % or higher.

The Ni-containing particles have functions as an electrode catalyst and an electron conductor in the cermet layer. The composition of the Ni-containing particles is not limited any particular composition as long as they exhibit such functions.

Examples of Ni-containing particles include Ni particles, Ni—Fe alloy particles, and Ni—Co alloy particles. Among them, the Ni-containing particles are preferably Ni particles or Ni—Fe alloy particles.

Since Ni-containing particles have high electronic conductivity and have high activity as an electrochemical catalyst, they are suitably used as a constituent material for a hydrogen electrode. Note that in an SOEC, the Ni-containing particles may aggregate and become unevenly distributed, or migrate away from the vicinity of the solid electrolyte layer over the passage of time during which a current flows through the electrode, and as a result, the electrode may deteriorate.

Therefore, it is considered to adjust the average particle diameter of Ni-containing particles to a value within a range in which the aggregation of Ni-containing particles can be suppressed. However, as a result of repeated study by the inventors of the present application, it has been found that Ni contained in Ni-containing particles is re-oxidized irrespective of the average particle diameter of the Ni-containing particles, so that the Ni-containing particles are repeatedly re-oxidized and reduced and hence the migration of Ni-containing particles proceeds.

It is presumed that the migration of Ni-containing particles occurs when overpotential for the electrode reaction is applied to the electrode. The electrode is a composite electrode. Therefore, even when the electrode is in a reduction atmosphere as a whole, there may be a local area(s) which is in a relatively oxidation atmosphere. Therefore, there is a possibility that Ni may be re-oxidized in the area(s), which is in the relatively oxidizing atmosphere, in the electrode. When Ni is oxidized, the wettability of Ni to the electrolyte increases, whereas when Ni is reduced, the wettability decreases. Therefore, when Ni is oxidized, the electrode tends to peel off from the solid electrolyte layer, so that the durability of the electrode may deteriorate. Further, when NiO, which is an insulator, is formed in the electrode due to the oxidation of Ni, the electron path is cut off and the electrolytic reaction ceases to proceed in that part. As a result, the electrolytic characteristic of the electrode deteriorates.

Therefore, it is desired to suppress the re-oxidation and reduction of Ni in order to prevent the electrode from deteriorating due to the migration of Ni-containing particles.

Accordingly, an electrode according to the present disclosure includes a cermet layer containing Ni-containing particles and an Nb compound, so that the re-oxidation and reduction of Ni contained in Ni-containing particles is suppressed, and hence both the initial characteristics (electrolytic characteristic) and the durability are improved.

### [Nb Compound]

The Nb compound is a compound containing niobium (Nb). The mass ratio of Nb contained in the Ni compound is preferably 0.2 mass % or higher and 3.0 mass % or lower.

The Nb compound can have a non-stoichiometric composition according to the oxygen partial pressure in the surrounding atmosphere. Therefore, the Nb compound changes the oxidation state of Ni contained in Ni-containing particles present in the vicinity of the Nb compound. Therefore, the Nb compound contained in the cermet layer has a function of suppressing the oxidation of Ni contained in the Ni-containing particles.

The Nb compound preferably covers at least parts of the surfaces of the Ni-containing particles. The Nb compound further suppresses the oxidation of Ni contained in Ni-containing particles contained in the cermet layer by covering at least parts of the surfaces of the Ni-containing particles.

The ratio of the mass of Nb contained in the Nb compound to the mass of Ni contained in the Ni-containing particles is not limited any particular ratio, and can be adjusted according to the mass of Ni contained in the Ni-containing particles covered by the Nb compound. The ratio of the mass of Nb contained in the Nb compound to the mass of Ni contained in the Ni-containing particles is preferably 0.2 to 3.0 mass %. In this way, the effect of suppressing the oxidation of Ni contained in Ni-containing particles can be sufficiently obtained.

Examples of Nb compounds include various Nb-containing compounds such as niobium alkoxide, niobium oxide, niobic acid, niobium hydroxide, niobium chloride, niobium nitrate, niobium sulfate, niobium oxalate, and niobium formate.

Among them, the Nb compound is preferably niobium oxide. In the case where the Nb compound is niobium oxide, it is highly basic and has a function of preventing the electrode activity from deteriorating, which would otherwise be caused by the occurrence of coking. Note that the coking is a phenomenon in which carbon (C) is deposited in a hydrogen electrode due to an increase in the amount of CO generated by co-electrolysis of CO₂/H₂O in an SOEC.

The oxidation state of niobium in niobium oxide may be any of pentavalent, tetravalent, trivalent, divalent, and monovalent. Examples of niobium oxide include niobium monoxide (NbO), niobium dioxide (NbO₂), and niobium pentoxide (Nb₂O₅). Niobium oxide is obtained, for example, by firing.

The Nb compound may contain an element(s) other than Nb. The Nb compound preferably contains lanthanum (La). An Nb compound containing La can enhance the catalytic activity and stability as an electrochemical catalyst for Ni-containing particles compared with an Nb compound containing no La.

The Nb compound preferably contains 0.8 to 1.2 of La per one atomic weight of Nb contained in the Nb compound. In this way, it is possible to sufficiently enhance the catalytic activity and stability of Ni-containing particles.

The average thickness of the Nb compound which covers at least parts of the surfaces of the Ni-containing particles is, for example, 1 to 20 nm, and is preferably uniform. Note that the average thickness of the Nb compound can be calculated by observing a layer uniformly formed on the surfaces of Ni-containing particles by an electron microscope such as a scanning electron microscope (SEM: Scanning Electron Microscope) or a transmission electron microscope (TEM: Transmission Electron Microscope), or by analyzing the layer by a spectroscope such as an energy dispersive X-ray spectrometer (EDS: Energy Dispersive X-ray Spectrometer) accessory to them, and thereby measuring the layer. Note that the average thickness refers to an average value obtained by measuring a plurality of parts.

The cermet layer preferably contains electrolyte particles having oxide ion conductivity or having both oxide ion and electron conductivities in addition to the Ni-containing particles and the Nb compound. As the electrolyte particles, any material that can be used for a hydrogen electrode can be used without any particular restriction.

The electrolyte particles having oxide ion conductivity have at least a function as an oxide ion conductor. Examples of electrolyte particles having oxide ion conductivity include ceramic particles such as zirconium oxide particles and perovskite oxide particles. Examples of zirconium oxides include zirconia (ZrO₂) and stabilized zirconia. Examples of stabilized zirconia include ZrO₂ in which at least one stabilizer selected from the group consisting of Y₂O₃, Sc₂O₃, Yb₂O₃, Gd₂O₃, CaO, MgO, and CeO₂ is solid-dissolved. Examples of perovskite oxides include perovskite oxides represented by ABO₃ such as lanthanum strontium cobalt iron oxide (LSFM). Among them, yttria stabilized zirconia (YSZ) in which Y₂O₃ is solid-dissolved is preferably used.

Electrolyte particles having both oxide ion and electron conductivities have at least functions as an oxide ion conductor and an electron conductor. Examples of electrolyte particles having both oxide ion and electron conductivities include ceramic particles such as cerium oxide particles. Examples of cerium oxides include ceria (CeO₂) and doped ceria. Examples of doped ceria include ceria in which at least one rare earth element oxide selected from the group consisting of Sm₂O₃, Gd₂O₃, and Y₂O₃ is solid-dissolved. Among them, gadolinia-doped ceria (GDC) in which Gd₂O₃ is solid-dissolved is preferably used.

The average particle diameter of the electrolyte particles is not limited any particular diameters as long as the effects of the technology disclosed herein are exhibited. The average particle diameter of the electrolyte particles is, for example, 0.1 to 5 μm, and preferably 0.2 to 2 μm.

### [Composition of Cermet Layer]

The content of Ni-containing particles is the ratio of the mass of Ni-containing particles to the total mass of the Ni-containing particles, the Nb compound, and the electrolyte particles.

When the content of Ni-containing particles is too small, the total cell resistance may increase, and the efficiency of electrode reaction may also deteriorate. Therefore, the content of Ni-containing particles is preferably 30 mass % or higher. The content of Ni-containing particles is more preferably 40 mass % or higher.

On the other hand, when the content of Ni-containing particles is too large, the content of electrolyte particles decreases. As a result, the oxidation suppressing function of Ni contained in Ni-containing particles may decrease, or the strength of the cermet layer may decrease. Therefore, the content of Ni-containing particles is preferably 70 mass % or lower.

### [Porosity of Cermet Layer]

The porosity of the cermet layer is not limited any particular value, and an optimum porosity can be selected according to the purpose.

For example, when the cermet layer is used as the active layer of an electrode, the porosity of the active layer affects the electrolytic characteristic. When the porosity of the active layer is too small, the diffusivity of the gas decreases and the efficiency of the electrode reaction decreases. Therefore, the porosity of the active layer is preferably 15% or higher. The porosity is preferably 20% or higher, and more preferably 25% or higher.

On the other hand, when the porosity of the active layer is too large, the three-phase interface becomes relatively small, so that the efficiency of the electrode reaction decreases instead of increasing. Therefore, the porosity of the active layer is preferably 40% or lower. The porosity is preferably 35% or lower, and more preferably 30% or lower.

Further, for example, when the cermet layer is used as the diffusion layer of an electrode, the porosity of the diffusion layer affects the gas diffusivity, the strength, the electronic conductivity, and the like of the hydrogen electrode. In general, when the porosity of the diffusion layer is too small, the gas diffusivity decreases. Therefore, the porosity of the diffusion layer is preferably 40% or higher. The porosity is more preferably 45% or higher, and still more preferably 50% or higher.

On the other hand, when the porosity of the diffusion layer is too large, the strength and the electronic conductivity decrease. Therefore, the porosity of the diffusion layer is preferably 60% or lower. The porosity is preferably 58% or lower, and more preferably 55% or lower.

### [Active Layer and Diffusion Layer]

An electrode according to the present disclosure includes at least an active layer. In addition to the active layer, the electrode may include a diffusion layer formed on a surface of the active layer on the side thereof on which the electrolyte is disposed. That is, the electrode may include only the active layer, or may include the active layer and the diffusion layer formed on a surface of the active layer on the side thereof on which the electrolyte is disposed.

The active layer is a layer that serves as the reaction field of the electrolytic reaction. Since the active layer needs to transport oxide ions generated by the electrolytic reaction to the electrolyte, it needs to have high ionic conductivity.

Meanwhile, the diffusion layer is a layer for supporting the active layer. In a hydrogen electrode consisting of a laminate of a diffusion layer and an active layer, the electrode reaction occurs mainly in the active layer. Therefore, the diffusion layer does not necessarily have to have high ionic conductivity.

That is, the diffusion layer needs to have at least:
(a) a function for supporting the active layer formed on a surface of the diffusion layer on the side thereof on which the electrolyte layer is disposed;
(b) a function for diffusing the raw material for the electrolysis to the active layer;
(c) a function for transporting electrons necessary for the reduction reaction from the current collector to the active layer; and
(d) a function for discharging hydrogen generated in the active layer by the electrode reaction to the outside of the hydrogen electrode.

The composition of the diffusion layer is not limited any particular composition as long as it exhibits such functions.

The above-described cermet layer can be used as at least one of the active layer and the diffusion layer.

That is, an electrode according to the present disclosure may be any of:
(a) an electrode including only an active layer, in which the active layer consists of the above-described cermet layer;
(b) an electrode including a two-layer structure including an active layer and a diffusion layer, in which the active layer consists of the above-described cermet layer and the diffusion layer consists of a layer other than the above-described cermet layer;
(c) an electrode including a two-layer structure including an active layer and a diffusion layer, in which each of the active layer and the diffusion layer consists of the above-described cermet layer; and
(d) an electrode including a two-layer structure including an active layer and a diffusion layer, in which the diffusion layer consists of the above-described cermet layer and the active layer consists of a layer other than the above-described cermet layer.

When the diffusion layer or the active layer consists of a layer other than the above-described cermet layer (hereinafter, also referred to as a “second layer”), the composition of the second layer is not limited any particular composition. The second layer typically consists of a cermet containing second Ni-containing particles and electrolyte particles consisting of a solid oxide.

The second Ni-containing particles contained in the second layer may be those that have the same composition as that of the Ni-containing particles contained in the above-described cermet layer, or may be those that have a composition different from that of the Ni-containing particles.

Further, the electrolyte particles contained in the second layer may be those that have the same composition as that of the electrolyte particles contained in the above-described cermet layer, or may be those that have a composition different from that of the electrolyte particles.

In order to prevent the electrode from deteriorating due to the oxidation of the Ni-containing particles, at least the active layer of the electrode preferably consists of a cermet layer. Other feature related to the cermet layer are the same as those described above, and therefore descriptions thereof are omitted.

### [Use]

As described above, an electrode according to the present disclosure can be used not only for the hydrogen electrode of an SOEC but also for a fuel electrode of an SOFC. The SOFC has the same structure as that of the SOEC except that its use is different from that of the SOEC, and therefore the detailed description is omitted.

### [Manufacturing Method of Electrode]

An electrode according to the present disclosure can be manufactured by various methods. For example, in the case where the electrode have a single-layer structure, the electrode can be manufactured by:
(a) firing a first mixture containing a raw material for Ni-containing particles and a raw material for an Nb compound;
(b) forming a compact by using a second mixture containing the obtained Nb-compound-coated Ni-containing particles and a raw material for electrolyte particles;
(c) sintering the obtained compact; and
(d) subjecting the obtained sintered compact to a reduction process.

### [First Step]

A first step is a step of firing a first mixture containing a raw material for Ni-containing particles and a raw material for an Nb compound.

The raw material for Ni-containing particles is a raw material that becomes Ni-containing particles after being sintered and reduced. The type of raw material for Ni-containing particles is not limited any particular types, and an optimal raw material can be selected according to the purpose. Examples of raw materials for Ni-containing particles include an NiO powder, an Fe₂O₃ powder, an Fe₃O₄ powder, mixtures of metallic Fe and NiO or metallic Ni, a CoO powder, and a Co₂O₃ powder.

The raw material for the Nb compound is a raw material that becomes the Nb compound after being fired. The type of raw material for the Nb compound is not limited any particular types as long as it is a material from which the Nb compound can be generated after being fired. Examples of raw material for the Nb compound include niobium alkoxides such as niobium isopropoxide. Such a raw material for the Nb compound can be used as a solution (hereinafter, may also be referred to as an Nb raw material solution) dissolved in a solvent. Examples of solvents include alcohols such as ethanol, water, and mixed solvents of alcohol and water. The firing temperature may be, for example, 500° C. or higher and 1,000° C. or lower.

The method for obtaining an Nb compound from a raw material for the Nb compound is not limited any particular methods, and an optimal method can be selected according to the purpose. Examples of methods for obtaining an Nb compound include a method for synthesizing an Nb compound by using a synthesis method such as a hydrolysis method, an impregnation method, and a sol-gel process.

The raw material for the Ni-containing particles and the raw material for the Nb compound are preferably blended so that an Nb compound having a desired covering ratio can be obtained after being fired.

Further, for example, in the case of an Nb compound containing La, a raw material for La may be contained in the first mixture. The type of the raw material for La is not limited to any particular types, and an optimal raw material can be selected according to the purpose. Examples of raw materials for La include lanthanum alkoxides such as lanthanum isopropoxide.

### [Second Step]

A second step is a step of forming a compact by using a second mixture containing the obtained Nb-compound-coated Ni-containing particles. A raw material for electrolyte particles may be contained in the second mixture.

The raw material for electrolyte particles is a raw material that becomes electrolyte particles after being sintered. The type of the raw material for electrolyte particles is not limited any particular types, and an optimal raw material can be selected according to the purpose.

For example, in the case where the electrolyte particles are YSZ, examples of its raw material include:
(a) an YSZ powder having a desired composition; and
(b) a mixture of a ZrO₂ powder and an Y₂O₃ powder that are blended with each other so that a desired composition is obtained.

Further, a pore-forming material such as a carbon powder may be contained in the second mixture. A metal oxide, such as a NiO powder, contained in the raw material for Ni-containing particles added in the second mixture is subjected to a reduction process after the sintered compact is manufactured. During this process, the volume is reduced and pores are introduced into (i.e., formed in) the sintered compact. Therefore, the pore-forming material is not indispensable. However, the degree of freedom in regard to the control of the porosity is increased by adding a pore-forming material in the second mixture.

The Nb-compound-coated Ni-containing particles and the electrolyte particles are preferably blended with each other so that a cermet layer having a desired composition can be obtained after being sintered and reduced.

The method for manufacturing a compact is not limited any particular methods, and an optimal method can be selected according to the purpose. Examples of methods for manufacturing a compact include:
(a) a method in which: a slurry containing a second mixture is tape-formed; the obtained green sheet is laminated on a substrate (e.g., a compact for manufacturing a second layer); and the laminate is subjected to cold isostatic pressing (CIP); and
(b) a method in which a slurry containing a second mixture is manufactured; and the manufactured slurry is screen-printed on a surface of a substrate.

### [Third Step]

A third step is a step of sintering the obtained compact. Regarding the sintering conditions, optimal sintering conditions are preferably selected according to the compositions of the raw materials. The sintering is preferably carried out at a temperature of 1,000° C. or higher and 1,400° C. or lower for one to five hours in an atmospheric atmosphere.

In the case where two or more types of oxides are contained in the second mixture, a solid-state reaction may proceed during the sintering, so that a solid solution having a predetermined composition may be generated. Further, in the case where a pore-forming material is contained in the second mixture, the pore-forming material disappears and pores are formed in the sintered compact during the sintering.

### [Fourth Step]

A fourth step is a step of subjecting the obtained sintered compact to a reduction process. As a result, a cermet layer is formed, so that an electrode including the cermet layer is obtained. The reduction process is carried out in order to reduce the metal oxide(s) such as NiO contained in the sintered compact and thereby to generate Ni-containing particles. The reduction conditions are not limited any particular conditions, and optimal conditions are preferably selected according to the composition of the cermet layer. The reduction is preferably carried out at a temperature of 600° C. or higher and 800° C. or lower in a hydrogen reduction atmosphere.

Note that an SOEC consists of, for example, an assembly having a structure of “hydrogen electrode (cathode)/electrolyte layer/oxygen electrode (anode)”. The reduction of the cermet layer is typically carried out after the layers are joined to each layer. This feature applies to an SOFC.

### EXAMPLES

The present disclosure will be described hereinafter in a more specific manner by using examples, but the present disclosure is not limited by the examples shown below. Further, in the examples, results of evaluations of the co-electrolysis of CO₂/H₂O in SOECs are shown. However, the deteriorating mechanisms of electrodes in the electrolysis of CO₂ and the electrolysis of H₂O are similar to that of the co-electrolysis of CO₂/H₂O. Therefore, it is presumed that similar evaluation results may be obtained in the electrolysis of CO₂ and the electrolysis of H₂O.

### [1. Manufacturing of Sample]

### Example 1

[Coating of Ni-Containing Particles with Nb Compound]

### Synthesis Example 1

Niobium oxide (Nb oxide), which was used as the Nb compound with which surfaces of NiO particles, which were used as the Ni-containing particles, were to be coated, was synthesized by using a hydrolysis method.

Firstly, an NiO powder (1.98 g), which was used as a raw material for the Ni-containing particles, was added to an Nb raw material solution in which niobium isopropoxide (0.33 mL), which was used as a raw material for the Nb compound, had already been dissolved in anhydrous ethanol (50 mL), which was used as a solvent. Then, the obtained mixture was stirred at a room temperature for one hour, and a slurry of a first mixture was thereby obtained.

Next, 1 mL of distilled water was added to the obtained slurry of the first mixture, and the niobium isopropoxide contained in the first mixture was thereby hydrolyzed. Then, the resultant slurry was concentrated at 60° C. by using an evaporator, and a powder of the first mixture was thereby obtained.

Next, the obtained powder of the first mixture was fired at 400° C. for four hours. As a result, Nb oxide-coated NiO particles, in which the NiO particles were coated with the Nb oxide (covering ratio: 1 mass %), were obtained.

### Synthesis Example 2

Niobium oxide (Nb oxide), which was used as the Nb compound with which surfaces of NiO particles, which were used as the Ni-containing particles, were to be coated, was synthesized by using an impregnation method.

Firstly, an NiO powder (1.98 g), which was used as a raw material for the Ni-containing particles, was added to an Nb raw material solution in which niobium isopropoxide (0.33 mL), which was used as a raw material for the Nb compound, had already been dissolved in anhydrous ethanol (1 mL), which was used as a solvent. Then, the obtained mixture was dried and solidified through evaporation while being stirred, and a powder of a first mixture was thereby obtained.

Next, the obtained powder of the first mixture was fired at 400° C. for four hours. As a result, Nb oxide-coated NiO particles, in which the NiO particles were coated with Nb oxide, were obtained.

### Synthesis Example 3

Niobium oxide (Nb oxide), which was used as the Nb compound with which surfaces of NiO particles, which were used as the Ni-containing particles, were to be coated, was synthesized by using a sol-gel process.

Firstly, an NiO powder (1.98 g) and glycerin (10 mL), which were used as raw materials for the Ni-containing particles, were added in this order to an Nb raw material solution in which niobium isopropoxide (0.33 mL), which was used as a raw material for the Nb compound, had already been dissolved in anhydrous butanol (50 mL), which was used as a solvent. Then, the obtained mixture was stirred at 160° C. for 12 hours, and a gel of a first mixture was thereby obtained.

Next, the obtained gel of the first mixture was calcined at 300° C., and the glycerin contained in the first mixture was thereby decomposed. Then, the resultant gel was fired at 400° C. for four hours. As a result, Nb oxide-coated NiO particles, in which the NiO particles were coated with the Nb oxide (covering ratio: 1 mass %), were obtained.

An XPS (X-ray Photoelectron Spectroscopy) measurement, an SEM-EDS measurement, and an XRD (X-Ray Diffraction) measurement were carried out for the Nb oxide-coated NiO particles obtained in Synthesis Examples 1 to 3, respectively.

XPS patterns were acquired for the Nb oxide-coated NiO particles obtained in Synthesis Examples 1 to 3, respectively, by the XPS measurements carried out therefor. Then, it was confirmed, based on the XPS patterns, that the Nb compounds contained in the Nb oxide-coated NiO particles in all the synthesis examples were Nb₂O₅.

Further, the covering ratios of the NiO particles by the Nb oxides were calculated for the Nb oxide-coated NiO particles obtained in Synthesis Examples 1 to 3, respectively, based on their XPS patterns by the below-shown Expression (1). As a result, the covering ratio was 1 mass %.

$$( Amount of detected Nb ) / ( Amount of detected Ni and Nb ) \times 100 \qquad Expression ( 1 )$$

SEM images and elemental mapping images were acquired for the Nb oxide-coated NiO particles obtained in Synthesis Examples 1 to 3, respectively, by the SEM-EDS measurements carried out therefor. Then, for each of Synthesis Examples 1 to 3, the SEM image of the Nb oxide-coated NiO particles, the elemental mapping image of Ni, and the elemental mapping image of Nb were superimposed on one another. Then, it was confirmed that NiO was coated with Nb₂O₅ because, on the surfaces of the Nb oxide-coated NiO particles, there were Nb-derived element parts at places where there were Ni-derived element parts.

XRD patterns were acquired for the Nb oxide-coated NiO particles obtained in Synthesis Examples 1 to 3, respectively, by the XRD measurements carried out therefor. Then, it was confirmed that NiO was coated with Nb₂O₅ with a thickness of several nanometers because no Nb-derived peaks were detected in the XRD patterns.

### [Manufacturing of Solid Oxide Electrolytic Cell (SOEC)]

A powder of lanthanum strontium gallium magnesium oxide (LSGM) represented by a formula La₁₋ₓSrₓGa_{1-y}Mg_{y}O₃ (0<x<0.3, 0.0<y<0.3), which was used as a solid electrolyte, was formed by cold isostatic pressing, and an electrolyte layer compact having a diameter of 1.5 mm and a thickness of 0.5 mm was manufactured. An oxygen electrode compact having a diameter of 0.5 mm and a thickness of 30 μm was manufactured by screen-printing a slurry containing barium lanthanum cobalt oxide (BLC) represented by a formula Ba_{0.6}La_{0.4}CoO₃ on one of the surfaces of the manufactured electrolyte layer compact. Then, for each of Synthesis Examples 1 to 3, a hydrogen electrode compact was manufactured by screen-printing slurry of the second mixture containing Nb oxide-coated NiO particles obtained in the synthesis example on the other surface of the manufactured electrolyte layer compact. In this way, for each of Synthesis Examples 1 to 3, a disk-like laminate consisting of “hydrogen electrode compact/electrolyte layer compact/oxygen electrode compact” was manufactured.

For each of the laminates manufactured as described above, a platinum lead wire was attached to both surfaces of the laminate with a platinum mesh interposed therebetween. Then, the laminate was set in an alumina tube by using a glass seal. Then, after the laminate was dried, it was fired at 1,100° C. for 12 hours in the atmosphere. Next, the obtained sintered compact was subjected to a reduction process at 800° C. for two hours in a hydrogen reduction atmosphere. NiO contained in the hydrogen electrode compact was reduced to Ni by the reduction process.

An SOEC having a structure of “hydrogen electrode (cathode electrode)/electrolyte layer/oxygen electrode (anode electrode)” was manufactured as described above.

### Example 2

[Coating of Ni-Containing Particles with Nb Compound]

### Synthesis Example 4

La—Nb oxide, which was used as the Nb compound containing La with which surfaces of NiO particles, which were used as the Ni-containing particles, were to be coated, was synthesized by using a hydrolysis method.

Firstly, an NiO powder (4.95 g), which was used as a raw material for the Ni-containing particles, was added to an Nb raw material solution in which lanthanum isopropoxide (0.049 g), which was used as a raw material for La, and niobium isopropoxide (0.73 mL), which was used as a raw material for the Nb compound, had already been dissolved in anhydrous ethanol (50 mL), which was used as a solvent. Then, the obtained mixture was stirred at a room temperature for one hour, and a slurry of a first mixture was thereby obtained.

As for the manufacturing of Nb oxide-coated NiO particles, Nb oxide-coated NiO particles in which NiO particles were coated with La—Nb oxide (covering ratio: 1 mass %) were obtained by a method similar to the method in Synthesis Example 1 except that the first mixture was obtained as described above. Nb oxide-coated NiO particles in which NiO particles were coated with La—Nb oxide may also be referred to as La—Nb oxide-coated NiO particles.

An XPS measurement, an SEM-EDS measurement, and an XRD measurement were carried out for the La—Nb oxide-coated NiO particles obtained in Synthesis Example 4.

An XPS pattern was acquired for the La—Nb oxide-coated NiO particles obtained in Synthesis Example 4 by the XPS measurement carried out therefor. Then, it was confirmed, based on the XPS pattern, that the Nb compound containing La contained in the La—Nb oxide-coated NiO particles was LaNbO₅.

Further, the covering ratio of the NiO particles by the La—Nb oxide was calculated for the La—Nb oxide-coated NiO particles obtained in Synthesis Example 4 based on the XPS pattern by the below-shown Expression (2). As a result, the covering ratio was 1 mass %.

$$( Amount of detected La and Nb ) / ( Amount of detected Ni , La , and Nb ) \times 100 \qquad Expression ( 2 )$$

A SEM image and an elemental mapping image were acquired for the La—Nb oxide-coated NiO particles obtained in Synthesis Example 4 by the SEM-EDS measurement carried out therefor. Then, the SEM image of the La—Nb oxide-coated NiO particles, the elemental mapping image of Ni, the elemental mapping image of Nb, and the elemental mapping image of La were superimposed on one another. Then, it was confirmed that NiO was coated with LaNbO₅ because, on the surfaces of the La—Nb oxide-coated NiO particles, there were Nb-derived element parts and La-derived element parts at places where there were Ni-derived element parts.

An XRD pattern was acquired for the La—Nb oxide-coated NiO particles obtained in Synthesis Example 4 by the XRD measurement carried out therefor. Then, it was confirmed that NiO was coated with LaNbO₅ with a thickness of several nanometers because no La-derived peak was detected in the XRD pattern.

### [Manufacturing of Solid Oxide Electrolytic Cell (SOEC)]

An electrolyte layer compact and an oxygen electrode compact were manufactured by a method similar to the method in Example 1. Then, a mixed powder obtained by mixing the La—Nb oxide-coated NiO particles obtained in Synthesis Example 4 and a powder of LSFM represented by a formula La_{0.6}Sr_{0.4}Fe_{0.9}Mn_{0.1}O_{3-δ} at a mass ratio of 90:10, a plasticizer, and a binder were dispersed in an organic solvent in which a dispersant had already been dissolved, and a slurry of a second mixture was thereby obtained. As for the manufacturing of an SOEC, a disk-like laminate having a structure of “hydrogen electrode compact/electrolyte layer compact/oxygen electrode compact” was manufactured by a method similar to the method in Example 1 except that the second mixture was obtained as described above.

Next, the manufactured laminate was fired and the fired compact obtained by the firing was subjected to a reduction process by a method similar to the method in Example 1.

An SOEC having a structure of “hydrogen electrode (cathode electrode)/electrolyte layer/oxygen electrode (anode electrode)” was manufactured as described above.

### Comparative Example 1

An SOEC was manufactured by a method similar to the method in Example 1 except that NaO particles that were not coated with Nb oxide were used instead of the Nb oxide-coated NiO particles.

### Comparative Example 2

An SOEC was manufactured by a method similar to the method in Example 2 except that NaO particles that were not coated with La—Nb oxide were used instead of the La—Nb oxide-coated NiO particles.

### [2. Testing Method and Evaluation Result]

### [Co-Electrolysis Test]

Tests for the co-electrolysis of CO₂H₂O were carried out by using the obtained SOECs. The co-electrolysis conditions were as follows.
Temperature: 800° C.
Oxygen electrode atmosphere: Dred air (flow rate: 100 cc/min)
Hydrogen electrode atmosphere: Gas having a CO₂/H₂O ratio of 1 (30% CO₂-30% H₂O-1% H₂-39% Ar) (flow rate: 100 cc/min)

### [IV Characteristic]

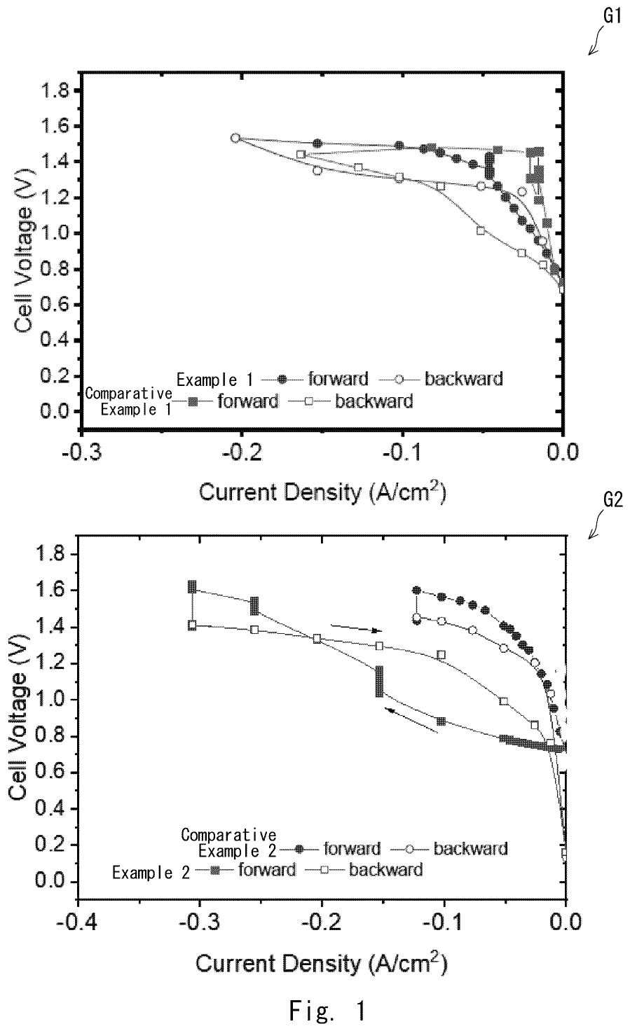

FIG. 1 shows graphs showing IV characteristics of the SOECs obtained in Examples 1 and 2 and Comparative Examples 1 and 2, respectively, during the co-electrolysis. In a graph G1 shown in FIG. 1, IV curves from OCV to about 1.5 V of the SOECs obtained in Example 1 and Comparative Example 1, respectively, during the co-electrolysis are shown in a superimposed manner. In a graph G2 shown in FIG. 1, IV curves from OCV to about 1.5 V of the SOECs obtained in Example 2 and Comparative Example 2, respectively, during the co-electrolysis are shown in a superimposed manner.

As can be seen from the graph G1 shown in FIG. 1, when the current densities at a voltage of 1.5 V are compared with each other, while the current density in Comparative Example 1 was about 0.17 A/cm², the current density in Example 1 was about 0.2 A/cm². Therefore, it has been found that the IV characteristic of Example 1 was higher than that of Comparative Example 1. It is presumed that this is because the oxidation of Ni contained in NiO particles was suppressed because Nb oxide was contained in the hydrogen electrode in Example 1.

Further, as can be seen from the graph G2 shown in FIG. 1, when the current densities at the voltage of 1.5 V are compared with each other, while the current density in Comparative Example 2 was about 0.12 A/cm², the current density in Example 2 was about 0.3 A/cm². Therefore, it has been found that the IV characteristic of Example 2, in which NiO particles were coated with La—Nb oxide, was higher than that of Comparative Example 2, in which NiO particles were not coated with La—Nb oxide. It is presumed that this is because the oxidation of Ni contained in Ni-containing particles was suppressed because NiO particles and La—Nb oxide were contained in the hydrogen electrode in Example 2.

### [AC Impedance]

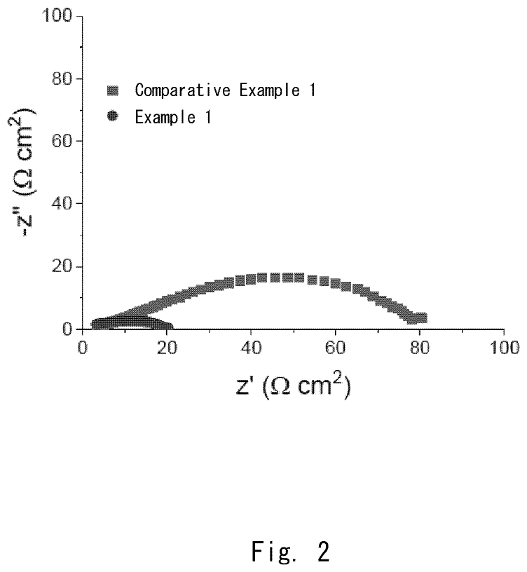

Impedances were measured for the SOECs obtained in Example 1 and Comparative Example 1, respectively, and Cole-Cole plots shown in FIG. 2 were thereby obtained. FIG. 2 shows the Cole-Cole plots of the SOECs obtained in Example 1 and Comparative Example 1, respectively.

As can be seen from FIG. 2, when the amounts of changes in the real parts of the complex impedances are compared with each other, the amount of change in the real part of the complex impedance in Example 1, in which the NiO particles were coated with Nb oxide, was smaller than that in Comparative Example 1, in which the NiO particles were not coated with Nb oxide. Therefore, it has been found that the resistance of the activation polarization of the hydrogen electrode was greatly reduced in Example 1. It is presumed that this is because the catalytic activity of NiO particles is enhanced because the NiO particles and Nb oxide are contained in the hydrogen electrode in Example 1.

### [Endurance Test]

Endurance tests were carried out by using the SOECs obtained in Example 1 and Comparative Example 1, respectively. The conditions for the endurance tests were as follows.
Cell temperature: 800° C.
Air electrode atmosphere: 79% N₂, 21% O₂
Hydrogen electrode atmosphere: 30% CO₂-30% H₂O-40% Ar

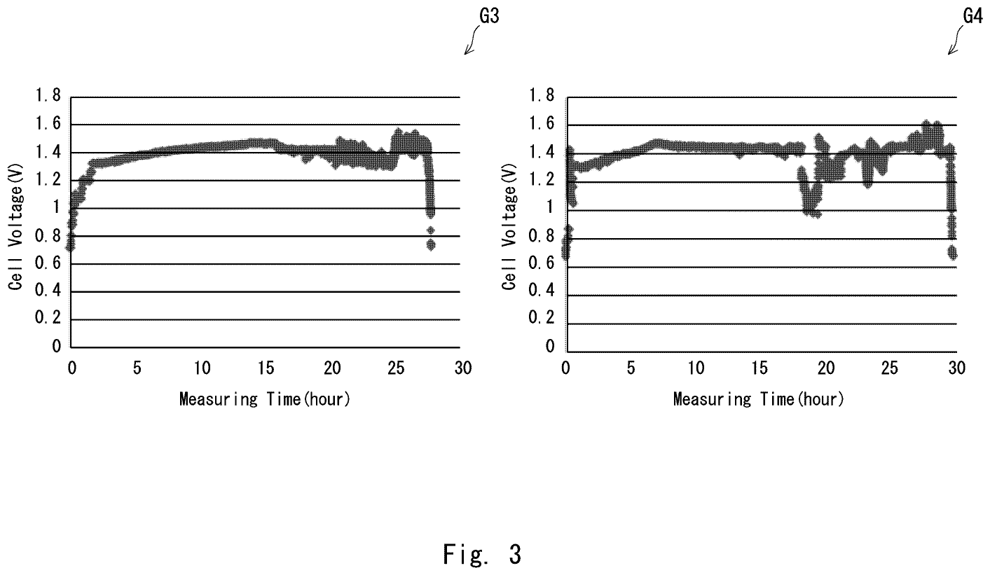

FIG. 3 shows graphs showing results of endurance tests of the SOECs obtained in Example 1 and Comparative Example 1, respectively. A graph G3 shown in FIG. 3 shows the transition of the cell voltage of the SOEC obtained in Example 1 during the co-electrolysis that was carried out with a constant current of 600 mA/cm². A graph G4 shown in FIG. 3 shows the transition of the cell voltage of the SOEC obtained in Comparative Example 1 during the co-electrolysis that was carried out with a constant current of 600 mA/cm².

As can be seen from the graph G4 shown in FIG. 3, it has been found that the cell voltage of Comparative Example 1 became unstable and hence the SOEC deteriorated about seven hours after the start of the evaluation. In contrast, as can be seen from the graph G3 shown in FIG. 3, the cell voltage of Example 1 was stable for about 15 hours after the start of the evaluation. Therefore, it has been found that the durability of the SOEC of Example 1 was higher than the SOEC of Comparative Example 1. It is presumed that this is because the oxidation of Ni contained in NiO particles was suppressed because NIO particles and Nb oxide was contained in the hydrogen electrode in Example 1.

Further, similar endurance tests were carried out by using the SOECs obtained in Example 2 and Comparative Example 2, respectively. Then, the deterioration ratio (%) was calculated from the cell voltage values before and after the endurance test by using the below-shown Expression (3).

$$( V 1 - V 0 ) / V 0 \times 100 \qquad Expression ( 3 )$$

In the expression, VO is the cell voltage at the start of the endurance test and VI is the cell voltage after the 30-hour endurance test.

As a result, while the deterioration ratio of Comparative Example 2 was 23%, the deterioration ratio of Example 2 was 0.4%. Therefore, it has been found that the durability of the SOEC of Example 2 was higher than the SOEC of Comparative Example 2. It is presumed that this is because the oxidation of Ni contained in NiO particles was suppressed because NiO particles and La—Nb oxide were contained in the hydrogen electrode.

[SEM Image of Hydrogen Electrode after Endurance Test]

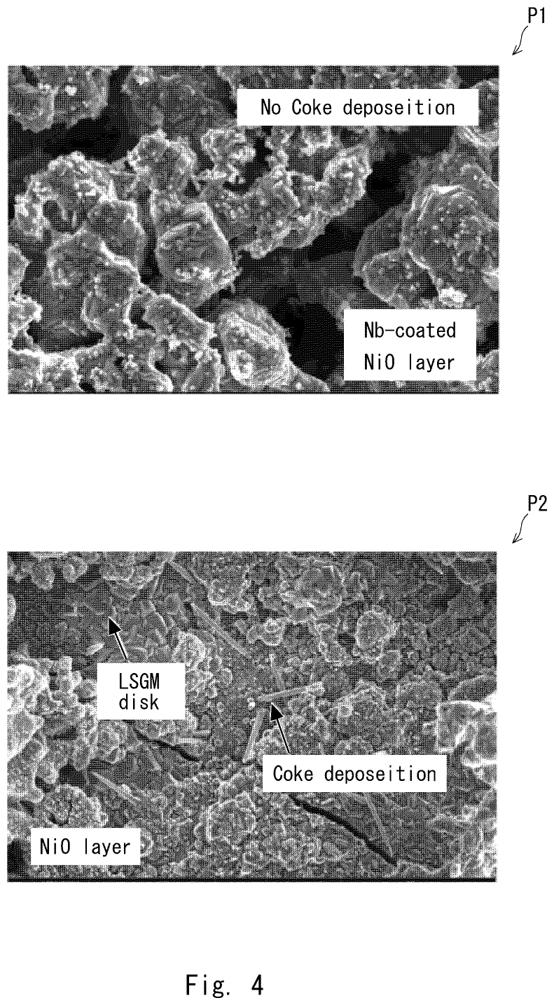

FIG. 4 shows SEM images of hydrogen electrodes after endurance tests. An SEM image P1 shown in FIG. 4 is an SEM image of the surface of the hydrogen electrode after the endurance test was carried out for the SOEC obtained in Example 1. An SEM image P2 shown in FIG. 4 is an SEM image of the surface of the hydrogen electrode after the endurance test was carried out for the SOEC obtained in Comparative Example 1.

As can be seen from the SEM image P2 shown in FIG. 4, needle-like deposited carbon was observed in some places in the hydrogen electrode in Comparative Example 1, so that it has been found that coking occurred. In contrast, as can be seen from the SEM image P1 shown in FIG. 4, no carbon deposition was observed in the hydrogen electrode in Example 1. Therefore, it has been found that the occurrence of coking was suppressed in the hydrogen electrode of Example 1 compared with the hydrogen electrode of Comparative Example 1. It is presumed that this is because, in the comparative example, the atmosphere in the electrode was nonuniform, and the reduction was locally strong in some places, so that CO was further reduced and carbon was deposited. In contrast, in the example, the niobium compound released oxygen when the reduction atmosphere was strong and absorbed oxygen when the oxidizing atmosphere was strong, so that it kept the oxidation-reduction atmosphere in the electrode uniform.

Similarly, although it is not shown in the drawings, based on the SEM images of the hydrogen electrodes after the endurance tests of the SOECs obtained in Example 2 and Comparative Example 2, respectively, while needle-like deposited carbon was observed in the hydrogen electrode in Comparative Example 2, no carbon deposition was observed in the hydrogen electrode in Example 2. Therefore, it has been found that the occurrence of coking was suppressed in the hydrogen electrode of Example 2 compared with the hydrogen electrode of Comparative Example 2. It is presumed that this is because of the same effects as those in Example 1.

### [XANES Spectrum]

XANES (X-ray Absorption Near Edge Structure) measurements were carried out on the SOECs obtained in Examples 1 and 2 and Comparative Examples 1 and 2, respectively. K-edge XANES spectra for Nb and K-edge radial distribution functions for Nb were acquired by XANES measurements carried out for the SOECs obtained in Examples 1 and 2 and Comparative Examples 1 and 2, respectively.

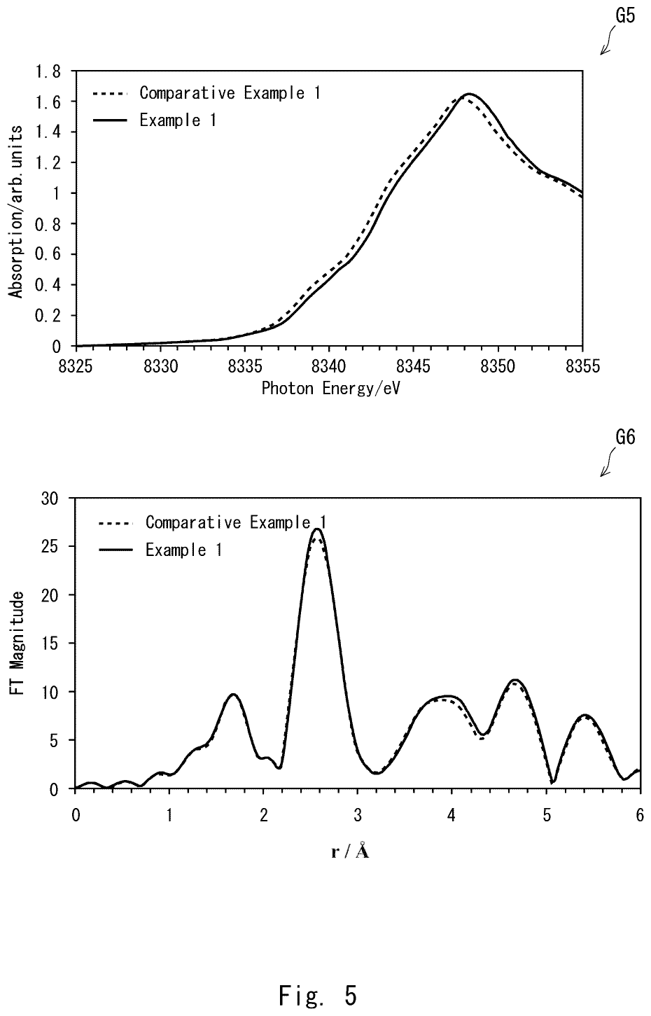

Firstly, FIG. 5 shows a graph of K-edge XANES spectra and a graph of K-edge radial distribution functions showing the results of the XANES measurements for the SOECs obtained in Example 1 and Comparative Example 1, respectively. In a graph G5 shown in FIG. 5, K-edge XANES spectra for Nb for the SOECs obtained in Example 1 and Comparative Example 1, respectively, are shown in a superimposed manner. In a graph G6 shown in FIG. 5, K-edge radial distribution functions for Nb for the SOECs obtained in Example 1 and Comparative Example 1, respectively, are shown in a superimposed manner.

Based on the K-edge XANES spectra and K-edge radial distribution functions shown in FIG. 5, Example 1 and Comparative Example 1 exhibited almost the same spectra and distributions. Therefore, it has been found that the electronic state of Ni contained in NiO particles was not changed by coating by Nb oxide.

Similarly, although it is not shown in the drawings, based on the K-edge radial distribution functions for K-edge XANESN for Nb, which shows the results of the XANES measurements for the SOECs obtained in Example 2 and Comparative Example 2, respectively, Example 2 and Comparative Example 2 exhibited almost the same spectra and distributions. Therefore, it has been found that the electronic state of Ni contained in NiO particles was not changed by coating by La—Nb oxide.

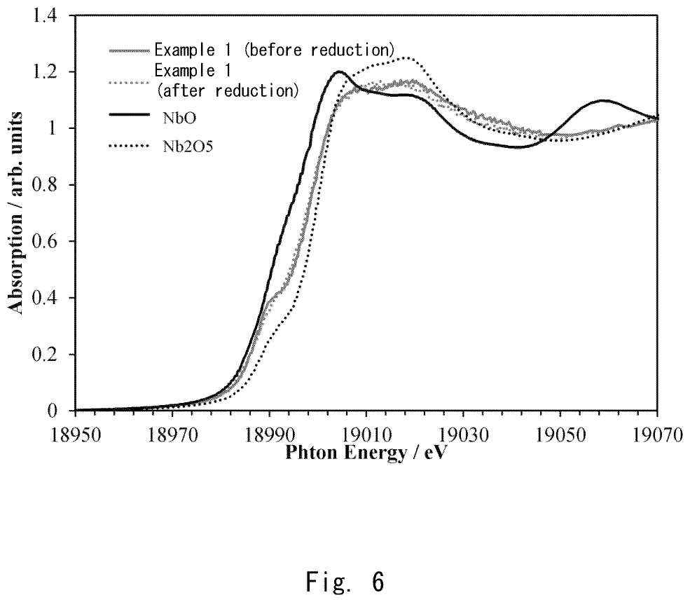

Next, FIG. 6 shows a graph showing K-edge XANES spectra showing the results of the XANES measurements for Nb oxide-coated NiO particles before and after the reduction processes. The K-edge XANES spectrum for Nb was acquired from the XANES measurements carried out for Nb oxide-coated NiO particles before and after the reduction process, which were carried out when the SOEC of Example 1 was manufactured. The graph shown in FIG. 6 shows the K-edge XANES spectra for Nb for Nb oxide-coated NiO particles before and after the reduction process in a superimposed manner. Note that in the graph shown in FIG. 6, the spectra of reference NbO and Nb₂O₅ are also shown.

Based on the K-edge XANES spectrum shown in FIG. 6, it has been found that the valence of Nb contained in the Nb oxide with which NiO particles were coated was three to four because of the absorption between NbO and Nb₂O₅. It is considered that the valence of Nb reversibly changes by the adsorption and desorption of oxygen.

Similarly, although it is not shown in the drawings, the K-edge XANES spectra of Nb and La, which show the results of the XANES measurements of the La—Nb oxide-coated NiO particles before and after the reduction process, was acquired which were carried out when the SOEC of Example 2 was manufactured. Based on the acquired K-edge XANES spectrum, it has been found that the valence of Nb contained in the La—Nb oxide with which NiO particles were coated was three to four because of the absorption between NbO and Nb₂O₅. Further, based on the acquired K-edge XANES spectrum, it has been found that the valence of La contained in the La—Nb oxide with which NiO particles were coated was three.

### [Analysis of Gas Generated by SOEC]

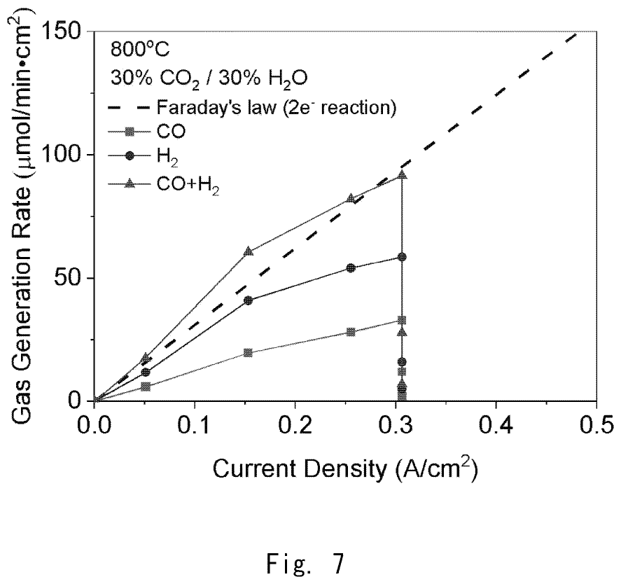

FIG. 7 shows a graph showing a result of an analysis of a gas generated by the SOEC obtained in Example 2. CO and H₂ were generated by supplying CO₂ and H₂O to the hydrogen electrode of the SOEC obtained in Example 2, and a current was made to flow between the electrodes. As shown in the graph shown in FIG. 7, the generation ratio of CO and H₂ in the SOEC obtained in Example 2 increased as the current density increased. Further, it has been found that the SOEC obtained in Example 2 could generate CO and H₂ with a Faraday effect of 100%.

Based on the examples shown above, it has been confirmed that the use of Nb oxide-coated NiO particles or La—Nb oxide-coated NiO particles for the hydrogen electrode of an SOEC could suppress the re-oxidation and reduction of Ni and suppress the occurrence of coking, and that consequently, the durability of the SOEC was improved.

Note that the present disclosure is not limited to the above-described embodiments, and they may be modified as desired without departing from the scope and sprit of the disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An electrode comprising a cermet layer containing Ni-containing particles and an Nb compound.

2. The electrode according to claim 1, wherein the Nb compound covers at least parts of surfaces of the Ni-containing particles.

3. The electrode according to claim 1, wherein a ratio of a mass of Nb contained in the Nb compound to a mass of Ni contained in Ni-containing particles is 0.2 to 3.0 mass %.

4. The electrode according to claim 1, wherein La is contained in the Nb compound.

5. The electrode according to claim 1, wherein the cermet layer contains electrolyte particles having oxide ion conductivity or both oxide ion and electron conductivities.
